(19) United States
(12) Patent Application Publication
(10) Pub. No.: US 2026/0069990 A1
(43) Pub. Date: Mar. 12, 2026

(54) TOY ASSEMBLIES FOR HANGING FROM AUTOMOBILE SEAT HEADRESTS AND METHODS OF USE

(71) Applicants: Mark Guenin, Wabash, IN (US); Natalie Beth Unger, Wabash, IN (US)

(72) Inventors: Mark Guenin, Wabash, IN (US); Natalie Beth Unger, Wabash, IN (US)

(21) Appl. No.: 19/322,960

(22) Filed: Sep. 9, 2025

Related U.S. Application Data
(60) Provisional application No. 63/692,471, filed on Sep. 9, 2024.

(51) Int. Cl. A63H 3/00; A47G 9/10; A63H 3/02; A63H 17/26; B60N 2/90; B65D 33/00; B65D 33/14

(52) U.S. Cl. CPC A63H 3/003; A47G 9/1045; A63H 3/02; A63H 17/26; B65D 33/004; B65D 33/14; B60N 2/90; B60N 2002/905

(57) ABSTRACT

Toy assembly for providing emergency medical information about a child passenger in an automobile. The toy assembly includes a hanger bag that can be hung from the headrest and a pillow that can be stored and/or removed from the hanger bag. The pillow is in the form of a plush pillow toy. The hanger bag has a pouch for the pillow, a hanger strap attached to the pouch for wrapping around an automobile seat headrest, and an opening into the pouch through which the pillow can be inserted and/or removed. The hanger strap includes an adjustable buckle. The pouch has a fillable emergency information form and child-interest graphics. At the scene of a traffic accident involving the automobile, an emergency responder is able to obtain the emergency medical information about the child passenger directly from the toy assembly adjacent to the child passenger.

### CROSS-REFERENCE TO RELATED APPLICATIONS

This application claims the benefit of provisional U.S. Patent Application No. 63/692,471 filed Sep. 9, 2024, the contents of which are incorporated herein by reference.

### BACKGROUND OF THE INVENTION

The invention relates generally to a toy assembly for providing emergency medical information about a child passenger in an automobile and methods related to the same.

Children in general are at risk when involved in a car crash. In 2021, for example, an estimated 162,298 children fourteen years of age or younger were injured in traffic crashes. An emergency first responder's access to emergency medical information about a child passenger involved in an automobile crash can be critical for providing appropriate care in a timely manner. In addition, children with certain types of disabilities are at a significantly higher risk of injuries than children without disabilities, although the characteristics of injuries are similar. It has been estimated that approximately 20% of children living in the United States—more than 14.5 million children total—have special health care needs. Thus, from a statistical standpoint, it can similarly be estimated that about 20% of children involved in car crashes in the United States would also have special health care needs. The emergency medical information for children with special health care needs is information that is particularly valuable to various emergency first responders, such as police and fire personnel, emergency medical technicians (EMTs), and any medical personnel that are needed to provide services to these children.

Various systems for making emergency medical information available to emergency first responders have been used in the past. Some traditional methods for making emergency medical information available to emergency first responders include placing written information, such as medical alert cards, in glove compartments, visors, or seatback organizers of an automobile in which a child is a passenger. Other products designed to store medical information in vehicles include seatbelt identification tags, visor pouches, and medical alert stickers. These types of “in the glove box” or “sticker on the car seat” solutions, or simply reliance on the adults in the car to provide such information in an emergency situation such as an automobile crash, can be of limited usefulness sometimes, such as if the emergency first responder cannot immediately see or access the information closed up in a glove box or a on a sticker or the adults in the automobile are themselves incapacitated or themselves do not know the needed information.

Therefore, it would be advantageous to have a system of making emergency information for a child passenger involved in an automobile crash more readily available to emergency first responders that provides improved visibility, accessibility, and/or reliability relative to previously known products and methods.

### BRIEF SUMMARY OF THE INVENTION

The intent of this section of the specification is to briefly indicate the nature and substance of the invention, as opposed to an exhaustive statement of all subject matter and aspects of the invention. Therefore, while this section identifies subject matter recited in the claims, additional subject matter and aspects relating to the invention are set forth in other sections of the specification, particularly the detailed description, as well as any drawings.

The present invention provides, but is not limited to, toy assemblies for providing emergency medical information about a child passenger and methods of using the toy assemblies.

According to one nonlimiting aspect, a toy assembly for providing emergency medical information about a child passenger in an automobile is provided. The toy assembly includes a hanger bag including a pouch defining an interior, an opening into the interior, and a hanger strap on an exterior of the pouch. The toy assembly also includes a pillow that can be inserted into the interior of the pouch through the opening for storage and removed from the interior of the pouch through the opening for use. A fillable emergency information form is included on a side of the pouch. The hanger strap is configured to be secured to an automobile seat headrest and hang from the back of the automobile seat headrest in front of a car seat for the child passenger.

According to still another nonlimiting aspect, a method is provided of using the toy assembly described above to provide emergency medical information to an emergency responder concerning a child passenger of an automobile. The method includes placing emergency medical information about the child passenger, including one or more of the child passenger's name, medical information, and emergency contact information, on the fillable emergency information form. The method also includes securing the hanger strap to a headrest of an automobile seat adjacent to a seat in which the child passenger is located, and hanging the pouch from the headrest. At a scene of a traffic accident involving the automobile, the emergency responder obtains the emergency medical information about the child passenger directly from the toy assembly adjacent to the child passenger.

These and other aspects, arrangements, features, and/or technical effects will become apparent upon detailed inspection of the figures and the following description.

### BRIEF DESCRIPTION OF THE DRAWINGS

FIG. 1 is a front side view of a two-piece plush toy assembly according to a first nonlimiting embodiment of the invention in a separated configuration.

FIG. 2 is an elevation view of the toy assembly in a combined configuration hanging from an automobile front seat headrest with a front side of the hanger bag facing toward the rear seat according to certain nonlimiting aspects of the invention.

FIG. 3 is an elevation view of the toy assembly in the combined configuration hanging from the automobile front seat headrest with the back side of the hanger bag facing toward the rear seat.

FIG. 4 is a front side view of another two-piece plush toy assembly according to a second nonlimiting embodiment of the invention in a separated configuration.

FIG. 5 is an elevation view of the toy assembly of FIG. 4 in a combined configuration hanging from an automobile front seat headrest with a front side of the hanger bag facing toward the rear seat according to certain nonlimiting aspects of the invention.

FIG. 6 is an elevation view of yet another two-piece plush toy assembly according to third nonlimiting embodiment of the invention in a combined configuration hanging from an automobile front seat headrest with a front side of the hanger bag facing toward the rear seat according to certain nonlimiting aspects of the invention.

### DETAILED DESCRIPTION OF THE INVENTION

The intended purpose of the following detailed description of the invention and the phraseology and terminology employed therein is to describe what is shown in the drawings, which include the depiction of and/or relate to one or more nonlimiting embodiments of the invention, and to describe certain but not all aspects of the embodiment(s) to which the drawings relate. The following detailed description also identifies certain but not all alternatives of the embodiment(s). As nonlimiting examples, the invention encompasses additional or alternative embodiments in which one or more features or aspects shown and/or described as part of a particular embodiment could be eliminated, and also encompasses additional or alternative embodiments that combine two or more features or aspects shown and/or described as part of different embodiments. Therefore, the appended claims, and not the detailed description, are intended to particularly point out subject matter regarded to be aspects of the invention, including certain but not necessarily all of the aspects and alternatives described in the detailed description.

To facilitate the description provided below of the embodiment(s) represented in the drawings, relative terms, including but not limited to, “proximal,” “distal,” “anterior,” “posterior,” “vertical,” “horizontal,” “lateral,” “front,” “rear,” “side,” “forward,” “rearward,” “top,” “bottom,” “upper,” “lower,” “above,” “below,” “right,” “left,” etc., may be used in reference to the orientation of the toy assemblies and their components during their use and/or as represented in the drawings. All such relative terms are useful to describe the illustrated embodiment(s) but should not be otherwise interpreted as limiting the scope of the invention.

As used herein the terms “a” and “an” to introduce a feature are used as open-ended, inclusive terms to refer to at least one, or one or more of the features, and are not limited to only one such feature unless otherwise expressly indicated. Similarly, use of the term “the” in reference to a feature previously introduced using the term “a” or “an” does not thereafter limit the feature to only a single instance of such feature unless otherwise expressly indicated.

The present application discloses a delivery system for providing emergency medical information for child passengers involved in traffic accidents in the form of a toy assembly. The toy assembly quickly provides this information to a first responder. The toy assembly may also significantly reduce the amount of stress and/or anxiety that a child experiences during this time of high stress and anxiety. In some embodiments, the toy assembly provides this emergency medical information at the point of immediate need, for example, at an automobile crash site. Children that have the toy assembly can have emergency medical information, such as their name, address, specific medical needs, special medical needs, and/or contact information for a loved one, immediately adjacent to them in an automobile involved in a crash. This information and its immediate accessibility are preferably capable of, for example, making a first responder's interaction with the child smoother and more productive at a time when this is needed most. Thus, the toy assembly is preferably capable of preserving and communicating medical information to emergency first responders in the event of emergencies and assisting young people with disabilities to communicate their disabilities to those same first responders in an emergency setting.

Turning now to the nonlimiting embodiments represented in the drawings, a toy assembly 10 includes a hanger bag 12 that can be hung from the headrest of an automobile seat and a pillow 14 that can be inserted into and removed from the hanger bag. The hanger bag 10 includes a pouch 16 with one or more sidewalls that define an interior cavity (not visible) in which the pillow 14 can be stored, an opening 20 defined by or through one or more of the pouch sidewalls into the interior cavity for allowing insertion and removal of the pillow, and a hanger strap 22 connected to or otherwise extending from an exterior of the pouch. The hanger bag 10, and in particular the pouch portion 16 of the hanger bag, can thus also be considered as a pillowcase for the pillow 14.

The pouch sidewalls form a front panel 18a and a back panel 18b. In this example, the sidewalls are formed by a single piece of flexible material, such as cloth, that is folded and sewn together about the outer periphery; however, the sidewalls could be formed of more pieces of cloth, define additional side panels, and/or be fastened together by other fastening mechanisms such as adhesive, thermal, and/or mechanical fasteners. In this example, the front and back panels 18a and 18b define a rectangular pouch having four edges: a top edge 24a, a bottom edge 24b, a left edge 24c, and a right edge 24d. The front and back panels 18a and 18b are fastened together along each of the top edge 24a, the bottom edge 34b, and the left edge. The panels 18a and 18b are not fastened together along the right edge 24d, thereby defining the opening 20 into the interior between the edges of the panels along the right edge. In other embodiments, the opening 20 could be defined along any one of the edges 24a-24d in similar fashion, and/or the opening 20 could be defined through any one of the sidewall panels 18a and/or 18b. In any event, the opening 20 is sized such that the pillow 14 can fit through the opening 20 to insert the pillow into the interior cavity and/or remove the pillow from the interior cavity.

The hanger strap 22 is attached to the top edge 24a of the pouch 16 and is sized to fit over and/or wrap around an automobile seat headrest 30 as shown in FIGS. 2 and 3. To make it easier to secure the hanger strap around the headrest 30, the hanger strap may be made of two separate strap portions 22a and 22b and a buckle 26 that fastens the two strap portions 22a and 22b together. One end of each strap portion 22a and 22b is attached to the top edge 24a of the pouch 16, and the other end of each strap portion 22a and 22b carries an interlocking portion of the buckle 26 so that the ends of the strap portions can be coupled and uncoupled using the buckle. The buckle 26 includes a sliding mechanism 28 so that the length of the hanger strap 22 may be adjusted by sliding one of the interlocking buckle portions along the length of its respective strap portion to shorten or lengthen the effective length of that strap portion. The buckle 26 and the sliding mechanism 28 can be used to easily install the hanging bag 12 onto the headrest 30 and adjust the height at which the pouch 16 hangs down from the headrest. As shown in FIGS. 2, 3, 5, and 6, it is anticipated that the hanger bag 12 will be hung such that the pouch 16 hangs downwardly on the back side of the seat (e.g., the driver seat or front passenger seat) in front of a car seat for the child. The hanger strap 22 and buckle 26 and sliding mechanism form a clamping mechanism that fits around the headrest 30, for example by being looped around the headrest, and can be easily adjusted to firmly hold/clamp the pouch 16, and optionally the pillow 14 therein, in place against the headrest behind the seat. The hanger strap 22 also allows the pillow 14 to be accessible to the children in the back seat.

The pouch 16 preferably has one or more first child-interest graphics 32 on the exterior of the front panel 18a. The child-interest graphics 32 may include pictures, symbols, and/or words that are likely to be of interest to a child. A fillable emergency information form 34 is printed on the back side 18b of the pouch. As best seen in FIG. 3, the fillable emergency information form 34 includes prompts and one or more accompanying blank lines each for a child's name, medical information, emergency contact name, emergency contact relationship, and emergency contact telephone number. The same fillable emergency information form 34 is on the back panel 18b of each of the embodiments shown in the drawings. The emergency information is not limited to the types of information described here nor are all the described types of emergency information required. Other information prompts could be used. The user can then easily fill in the fillable emergency information form 34 by writing emergency information about a child onto the back panel 18b in the appropriate blank spaces provided and/or pasting or otherwise attaching such information to the form, such as in the spaces provided.

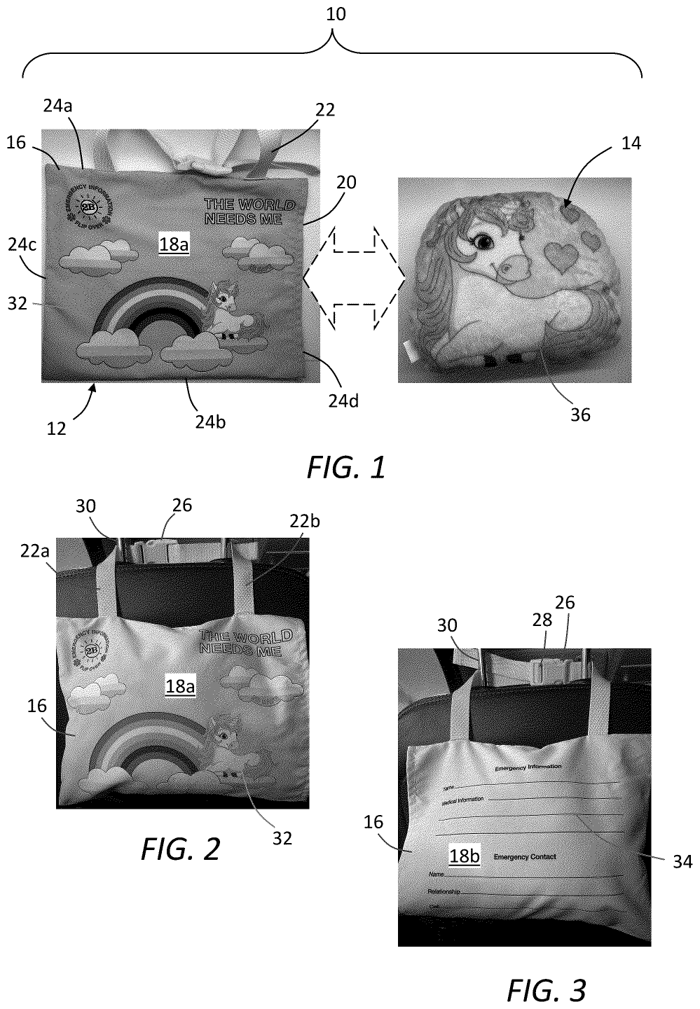

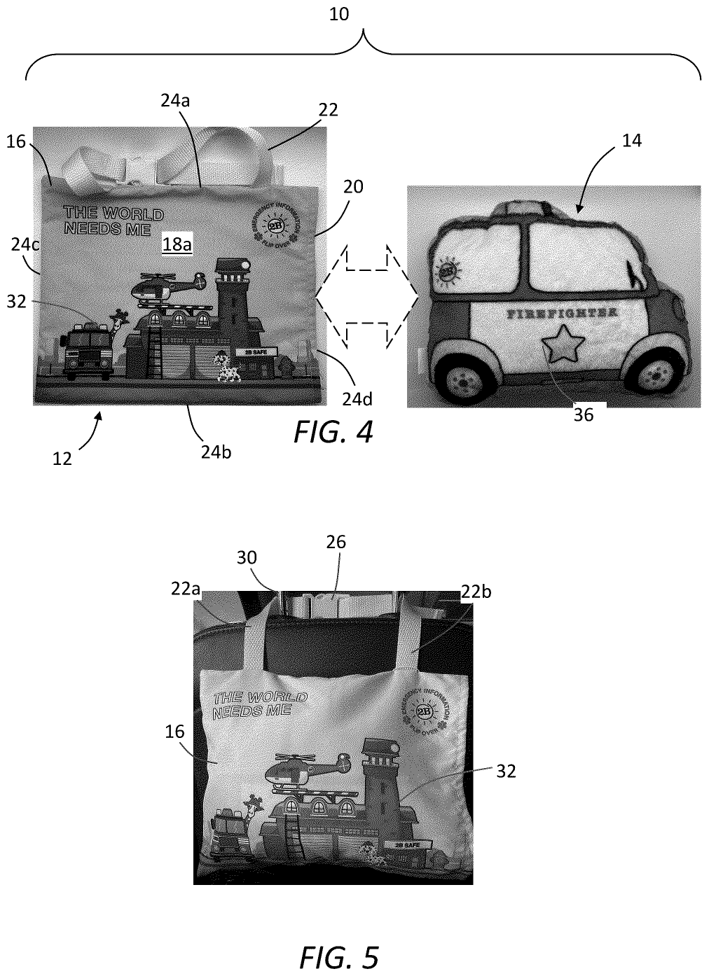

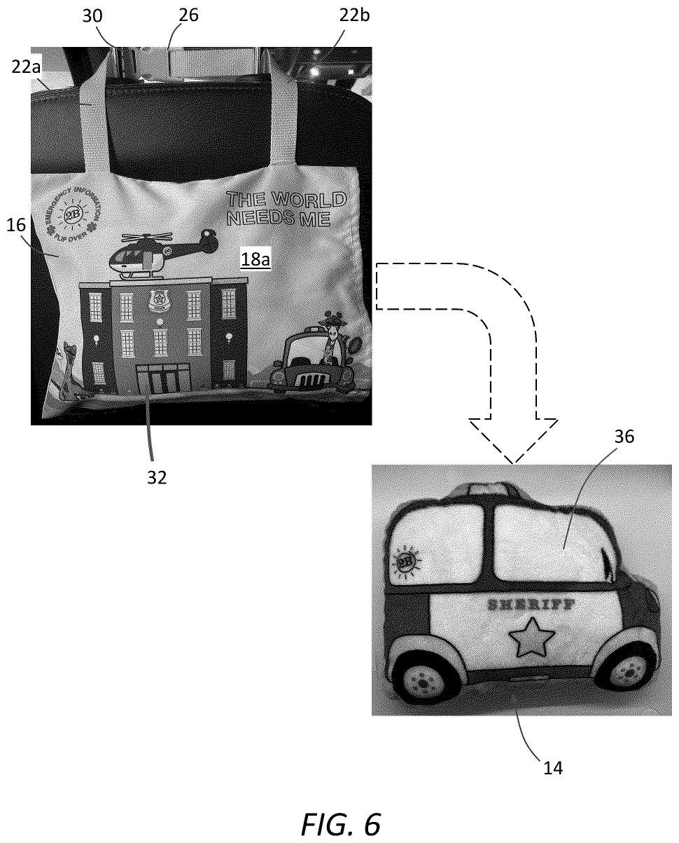

The pillow 14 is preferably formed of a plush cloth with a soft filling so as to form a plush pillow toy. However, other designs could be used. The pillow 14 is sized and shaped such that it can be inserted into the interior cavity of the pouch 16 for storage and the removed for use. The pillow 14 may have a second set of child-interest graphics 36 printed thereon and/or have a child-interest shape that corresponds with the child-interest graphics 32. The pillow 14, graphics 36, and shape are preferably selected to be logically associated with the graphics 32 on the pouch 16 so as to have a common subject matter theme. For example, in the embodiment of FIGS. 1 and 2, the child-interest graphic 32 includes a cartoon picture of a rainbow and a unicorn, and the associated pillow 14 has the shape and graphics 36 of a unicorn. In the embodiment of FIGS. 4 and 5, the child-interest graphic 32 includes a cartoon picture of a fire station, fire truck, animal, and helicopter, and the associated pillow 14 has the shape and graphics 36 of a fire truck. In the embodiment of FIG. 6, the child-interest graphic 32 includes a cartoon picture of a police station, police car, animals, and helicopter, and the associated pillow 14 has the shape and graphics 36 of a police care. Other graphics and shapes for other subject matter themes could be used.

The toy assembly 10 has several advantages over previously known products and methods for making emergency medical information for a child (or other person) available to emergency personnel at the scene of an emergency event, such as a car crash. Unlike traditional storage solutions (glove compartments, visors, or seatback organizers), the toy assembly 10 can provide a pillowcase functionality, for example, integrating a soft, cushioned surface with a storage function, potentially providing comfort for passengers while serving a life-saving purpose. In addition, instead of simply providing loose pockets or straps, the toy assembly 10 can securely clamp onto the back of the driver's seat or front passenger's seat with the adjustable hanger strap 22, ensuring it stays in place and is easily accessible, with the ability to offer a more stable and visible location to emergency personnel compared to traditional pouches or folders that are stored in a glove compartment or seatback organizer.

The toy assembly 10 preferably provides dedicated emergency medical information storage. Thus, for example, although medical alert cards or stickers exist, the fillable emergency information form 34 offers a specifically designated and protected space for storing critical medical information (e.g., allergies, conditions, emergency contacts). First responders would know exactly where to look, reducing search time in an emergency. In addition, the fillable emergency information form 34 provides a pre-defined location for providing emergency contact information to emergency responders and/or law enforcement personnel, with the ability to provide for a more rapid response and contact to family or friends to care for small children in an emergency situation.

In some embodiments, the toy assembly 10 can provide improved visibility and accessibility to the emergency medical information for a child or person with a disability in the automobile. For example, the toy assembly 10 may include labeling, such as a medical symbol and/or informative text, such as “Emergency Info Inside”, that would clearly identify the toy as including important emergency information so that first responders could instantly recognize its purpose. Locating the toy 10 on the back of the driver's seat or passenger's seat is also an intuitive and easily accessible location for such information, unlike glove compartments that may be locked or hard to reach in an accident.

In addition, the toy assembly 10 can be used for multiple purposes. For example, beyond just providing emergency medical information, the pouch 16 can act as a pillowcase for the pillow 14. In addition, the pouch 16 and the pillow 14 are preferably capable of providing a feeling of comfort and security to a young child or person with disabilities that is undergoing a crisis situation due to its familiarity and use as a toy. The concept of a pillowcase that attaches to the back of a driver's seat and includes a designated space for medical information can be particularly helpful for emergency preparedness. The pillow 14, pillowcase and strap, features of the toy assembly 10 can provide a useful recording and delivery system for emergency medical information that needs to be with the child at the time of an emergency.

Use of the toy assembly 10 in the manner described herein can help provide valuable peace of mind to parents, grandparents, extended family members, and friends that are transporting children. Having information recorded on the fillable emergency information form 34 or elsewhere on the toy assembly 10 that explains, for example, that a child passenger is non-verbal, or autistic, or suffers from hemophilia, or has specific allergies, or any other special medical need, allows for the care of the child at the time of need in an emergency situation in a manner that understands and acknowledges their special needs. The toy assembly 10 can thus benefit the child, the child's parents/guardians, and/or people, such as emergency first responders, providing services to the child at a crash site.

As previously noted above, though the foregoing detailed description describes certain aspects of one or more particular embodiments of the invention, alternatives could be adopted by one skilled in the art. For example, the toy assembly 10 and its components could differ in appearance and construction from the embodiments described herein and shown in the drawings, functions of certain components of the toy assembly 10 could be performed by components of different construction but capable of a similar (though not necessarily equivalent) function, and various materials could be used in the fabrication of the toy assembly 10 and/or its components. As such, and again as was previously noted, it should be understood that the invention is not necessarily limited to any particular embodiment described herein or illustrated in the drawings.

1. A toy assembly for providing emergency medical information about a child passenger in an automobile, the toy assembly comprising:
a hanger bag comprising a pouch defining an interior, an opening into the interior, a hanger strap on an exterior of the pouch; and
a pillow that can be inserted into the interior of the pouch through the opening for storage and removed from the interior of the pouch through the opening for use; and
wherein the pouch comprises a fillable emergency information form on a side of the pouch;
wherein the hanger strap is configured to be secured to an automobile seat headrest and hang from the back of the automobile seat headrest in front of a car seat for the child passenger.

2. The toy assembly of claim 1, wherein the pouch comprises a front panel and a back panel secured together along outer peripheral edges thereof surrounding the interior.

3. The toy assembly of claim 2, wherein each of the front panel and the back panel together define a top edge, a bottom edge, a left edge, and a right edge, and wherein the hanger strap is secured to the pouch at the top edge.

4. The toy assembly of claim 3, wherein the opening into the interior is disposed along at least one of the left edge and the right edge.

5. The toy assembly of claim 4, wherein the opening is defined between the front panel and the back panel.

6. The toy assembly of claim 1, wherein the hanger strap comprises a first strap portion secured to the pouch, a second strap portion secured to the pouch, and a buckle that releasably couples an end of the first strap portion to an end of the second strap portion.

7. The toy assembly of claim 6, wherein the buckle is slidingly coupled to at least one of the first strap and the second strap and with a sliding mechanism configured to allow a total length of the hanger strap to be adjusted.

8. The toy assembly of claim 1, wherein the pouch comprises a first child-interest graphic on a front side of the pouch.

9. The toy assembly of claim 8, wherein the first child-interest graphic comprises at least one of a rainbow, a unicorn, a firetruck, a fire station, a police car, a police station, a helicopter, and a cartoon animal.

10. The toy assembly of claim 8, wherein the first child-interest graphic comprises an affirmational message.

11. The toy assembly of claim 1, wherein the fillable emergency information form comprises prompts and one or more accompanying blank lines for one or more of a child's name, medical information, emergency contact name, emergency contact relationship, and emergency contact telephone number.

12. The toy assembly of claim 1, wherein the pillow comprises a plush toy having one or more second child-interest graphics and/or child-interest shapes.

13. The toy assembly of claim 12, wherein the second child-interest graphics comprises a picture of at least one of a unicorn, a firetruck, and a police car.

14. The toy assembly of claim 12, wherein the child-interest shape comprises at least one of a unicorn, a firetruck, and a police car.

15. A method of using the toy assembly of claim 1 to provide emergency medical information to an emergency responder concerning a child passenger of an automobile, the method comprising:
placing the emergency medical information about the child passenger comprising at least one of the child passenger's name, medical information, and emergency contact information on the fillable emergency information form;
securing the hanger strap to a headrest of an automobile seat adjacent to a seat in which the child passenger is located; and
hanging the pouch from the headrest;
wherein, at a scene of a traffic accident involving the automobile, the emergency responder obtains the emergency medical information about the child passenger directly from the toy assembly adjacent to the child passenger.

16. The method of claim 15, wherein the step of securing comprises hanging the pouch downwardly from the headrest on a rear side of the automobile seat.

17. The method of any claim 15, further comprising writing the emergency medical information about the child passenger directly onto the fillable emergency information form on the pouch.

18. The method of claim 15, further comprising inserting the pillow into the interior of the pouch and/or removing the pillow from the interior of the pouch while the pouch is hanging from the headrest.

19. The method of claim 15, wherein the step of securing the hangar strap comprises releasably coupling with a buckle an end of a first strap portion secured to the pouch to an end of a second strap portion secured to the pouch.

20. The method of claim 19, further comprising clamping the pouch against the headrest by adjusting a length of the hanger strap with a sliding mechanism of the buckle.
